(19) United States
(12) Patent Application Publication
(10) Pub. No.: US 2021/0374497 A1
(43) Pub. Date: Dec. 2, 2021

(54) GENUINE PRODUCT MULTI-LAYERED SECURITY AND AUTHENTICATION

(71) Applicant: Genuine Product Authenticators LLC, Dearborn, MI (US)

(72) Inventor: Sajjad Syed, West Bloomfield, MI (US)

(21) Appl. No.: 16/885,179

(22) Filed: May 27, 2020

(51) Int. Cl. G06K 19/07; G06K 7/10; H04W 4/80; H04L 9/08

(52) U.S. Cl. CPC G06K 19/0727; G06K 7/10386; H04L 2209/805; H04L 9/0869; H04W 4/80

(57) ABSTRACT

A system and method for providing product security and brand authentication, and more specifically, to a system and method for providing a secure system for identifying and authenticating a product brand while in a distribution channel is disclosed. The system uses RFID tags attached to products and in product packaging to identify whether the product is a genuine item. The RFID tag stores an encrypted data that identifies the product, its source, and related information. The data is used when contacting a remote server to perform the authentication. Each time the RFID tag is read, the stored data is changed making the data difficult to impossible to fake.

### TECHNICAL FIELD

This application relates in general to a system and method for providing product security and brand authentication, and more specifically, to a system and method for providing a secure system for identifying and authenticating a product brand while in a distribution channel.

### BACKGROUND

Fake merchandise is a massive industry. Fake manufacturers have become excellent at duplicating the real products to an undetectable level in record tum-around time. If a consumer wants to purchase a guaranteed authentic product, he/she needs to buy it from an authorized dealer. With the fake merchandise business nearing $2 trillion, online retailers are trying to solve this problem via customer feedback, supply chain monitoring, and authorized sellers flagging unauthorized ones. Currently, no universal solution exists to combat fake manufacturers.

Therefore, a need exists for a secure and simple system to identify and authenticate a product's brand once an item is in a distribution channel as it travels from a manufacturer to a retailer for sale to a buyer and thereafter. The system may also be useful to authenticate the item at the retailer when the buyer has selected the item for purchase in order to provide buyers with assurance that the item being purchased is authentic.

### SUMMARY

In accordance with the present invention, the above and other problems are solved by providing a system and method for identifying and authenticating a product brand while in a distribution channel according to the principles and example embodiments disclosed herein.

In one embodiment, the present invention is a system for identifying and authenticating a product brand while in a distribution channel. The system uses RFID tags attached to products and in product packaging to identify whether the product is a genuine item. The RFID tag stores an encrypted data that identifies the product, its source, and related information. The data is used when contacting a remote server to perform the authentication.

Each time the RFID tag is read, the stored data is changed making the data difficult to impossible to fake.

In another embodiment, the present invention is a method for identifying and authenticating a product brand while in a distribution channel. The method reads data from an RFID tag attached to a product for authentication. The data is decrypted and sent to a remote server for authentication. Results of the authentication are returned to the scanner and the stored data is modified, encrypted and stored onto the RFID tag.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiments disclosed may be readily utilized as a basis for modifying or designing other ways to carry out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for a system for identifying and authenticating a product's brand while in a distribution channel according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIG. 3 illustrates another example embodiment of a system to identify and authenticate a product's brand while in a distribution channel according to the present invention.

FIG. 4a-b illustrates a computing system of software components that identify and authenticate a product's brand while in a distribution channel according to the present invention.

FIG. 5a-b illustrate flowcharts corresponding to methods performed by software components to identify and authenticate a product's brand while in a distribution channel according to the present invention.

FIG. 6 illustrates a flowchart describing a method of generating a token/cypher data using encryption and decryption according to the present invention.

FIG. 7 illustrates a flowchart corresponding a method performed by software components that configures an RFID tag for use to identify and authenticate a product brand while in a distribution channel according to the present invention.

### DETAILED DESCRIPTION

This application relates in general to a system and method for providing product security and brand authentication, and more specifically, to a system and method for providing a secure system for identifying and authenticating a product brand while in a distribution channel.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The term “mobile application” refers to an application executed on a mobile device such as a smartphone, tablet, and/or web browser on any computing device.

The terms “customer” and “user” refer to an entity, e.g. a human, using the Genuine Product Multi-Layered Security and Authentication system or method including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or to a wireless connection(s) using any type of frequency/frequencies or radio wave(s). Some examples are included below in this application.

The term “radio frequency identification” or “RFID” refers to a system that utilizes wireless non-contact radio frequency waves to transfer data.

The term “invention” or “present invention” refers to the invention being applied for via the patent application with the title “Genuine Product Multi-Layered Security and Authentication.” Invention may be used interchangeably with RFID system.

The terms “communicate”, or “communication” refer to any component(s) connecting with any other component(s) in any combination for the purpose of the connected components to communicate and/or transfer data to and from any components and/or control any settings.

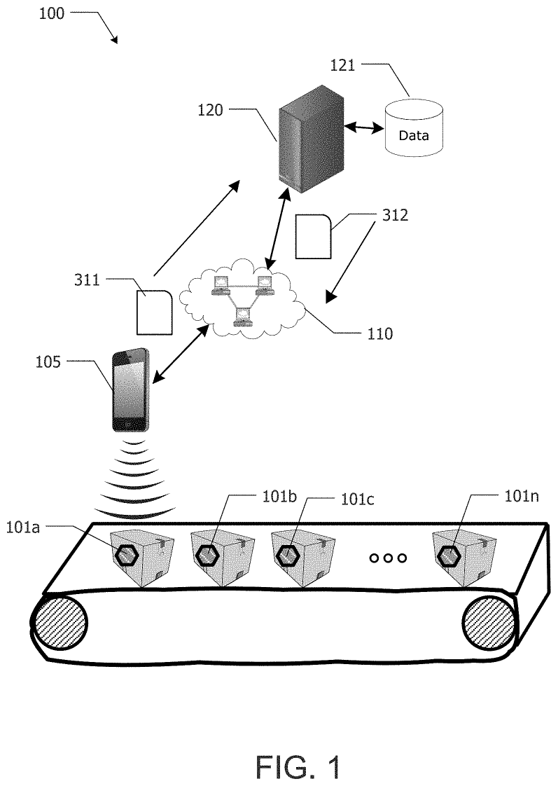

In general, the present disclosure relates a system and method for identifying and authenticating a product's brand while in a distribution channel. To better understand the present invention, FIG. 1 illustrates an example embodiment for a system 100 to identify and authenticate a product's brand while in a distribution channel according to the present invention. A RFID reader may be a mobile application executing on a smartphone 105 that may include an internal NFC transceiver, or may have an external transceiver coupled to it. The mobile application controls the operation of the RFID functions as well as communication to a remote server 120 for verification of an RFID tag 101a.

Products from a particular manufacturer or source may include an RFID tag 101a-n either within the product itself or in its packaging. At various points along the distribution channel, the mobile application and RFID reader may be used to scan the products to obtain recorded data useful in identifying and authenticating the source of the products. The smartphone 105 may communicate with the remote server 120 via the Internet 110 to verify any information received from the tags 101a-n and to receive updated data for storage onto the tags 101a-n. The server 121 may include a datastore for holding all of the information expected to be found on the tags 101a-n for use in any verification of the tags as needed. Additionally, any of the processing of tag data may occur either on the smartphone 105 or the server 120 to verify any tag and authenticate its source, as well as update the tag data as a result of the verification and authentication. The location of any processing operation between the smartphone 105 and the server 120 is a matter of design choice related to how the overall system works with multiple readers in use at one time.

The RFID technology used in the system 100 is based upon a very simple idea that has many complications involved in its execution. A reader/interrogator/scanner in the smartphone 105 transmits an RF wave to a tag 101a-n. The tag 101a “hears” the RF wave and responds with some data. Tags come in many styles, including passive, battery assisted, active, backscatter, different frequencies, tag talks first, reader talks first, various anti-collision techniques or not, printed antennas, wire wound antennas, hard case, and label.

An RFID system consists of three components: a tag 101a (or multiple tags), also called transponder, reader or interrogator, which may include a mobile application on a smartphone 105 together with antenna and supporting infrastructure (hardware and software).

The tag 101a comes in a variety of shapes. It is made up from a chip (IC) and an antenna. The tag 101a may be embedded in glass or epoxy, or it may be in a label or a card. The tag 101a may be passive, battery assisted, or active.

Passive tags get all their power from the signal sent by the interrogator. As well as using this radio wave to carry the data, the tag is able to convert it into power. This means that the tag is only powered when it is in the beam of the interrogator. The tag then uses a technique called backscatter to reply to the interrogator. This does not involve a transmitter on the tag, but is a means of “reflecting” the carrier wave and putting a signal into that reflection.

Battery-assisted tags are like passive tags (they use backscatter), but they have a battery to provide the power to the chip. This provides a big advantage, because the tag is not dependent on the strength of the carrier from the interrogator to provide the power it needs. Now it can use all the power from the battery and so is able to work at a greater distance from the interrogator.

Active tags have not only a battery, but also some form of transmitter on the tag and are able to work from long distances from the interrogator. The disadvantage of having a battery, however, is twofold. One, it adds cost to the tag and two, the battery runs out of power eventually. The decision on which one is right for you will depend on your application.

The tag is made of an IC and an antenna. The IC will include memory and some form of processing capability. The memory may be read only or read/write, the type selected will depend on the application. The tag talks to the interrogator/reader using what is called the air-interface. This is a specification for how they talk to each other and includes the frequency of the carrier, the bit data rate, the method of encoding, and any other parameters that may be needed. ISO 18000 is the standard for the air interface for item management. ISO/IEC JTC I/SC 31 is the

U.S. TAG (Technical Advisory Group), similar to the international standards group to SC 31 known as ADC, is responsible for defining and maintaining operating standards for RFID systems.

Also a part of this air interface is what is commonly called the anti-collision protocol (if the tag supports it). This is a means of allowing many tags in the field to talk “at the same time.” There are several ways to do this and each manufacturer has developed its own method of implementation.

The above tags may be a “reader talks first” (RTF) or a “tag talks first” (TTF) type of system. With an RTF system, the tag does not respond until it hears a request from the interrogator. This means that even though a tag may be illuminated (receiving power) by interrogator, it does not talk until it is asked a question. With TTF, the tag responds as soon as it gets power, or in the case of a battery assisted tag or active tag, it responds for short periods of time, all the time. This gives any interrogator a much faster indication of a tag within sight of the interrogator, but it also means that the airwaves have constant traffic.

The antenna in a tag is the physical interface for the RF to be received and transmitted. Its construction varies depending on the tag itself and the frequency it operates on. Low frequency tags often use coils of wire, whereas high frequency tags are usually printed with conducting inks.

The readers/interrogators communicate with the supporting infrastructure. This includes other hardware and software and is frequently the most complicated (and possibly expensive) part of the system. The software may just collate and deliver the data it gets from the readers or it may be a part of a much bigger system.

The invention may use any type of network such as a single network, multiple networks of the same type or multiple networks of different types which may include one or more of a direct connection between devices including, but not limited to, a local area network (LAN), a wide area network (WAN) (for example, the Internet), a metropolitan area network (MAN), a wireless network (for example, a general packet radio service (GPRS) network), a long term evolution (LTE) network, a telephone network (for example, a public switched telephone network or a cellular network), a subset of the Internet, an ad hoc network, a fiber optic network (for example, a fiber optic service often known as FiOS network), or any combination of the above networks.

Smart devices mentioned herein may also use one or more sensors to receive or send signals, such as wireless signals like Bluetooth™, wireless fidelity, infrared, Wi-Fi or LTE. Any smart device mentioned in this application may be connected to any other component or smart device via wired communications (e.g., conductive wire, coaxial cable, fiber optic cable, ethemet cable, twisted pair cable, transmission line, and waveguide) or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods are described without reference to the specific software or firmware code. Software, smart device application(s), firmware, and control hardware can be designed to implement the systems and methods based on the description herein.

While all of the above functions are described to be provided to users via a mobile application on a smartphone 105, one of ordinary skill will recognize that any computing device including tablets, laptops, and general purpose computing devices may be used as well. In at least one embodiment, all of the services described herein are provided using web pages being accessed from the web server 120 using a web browser such as Safari™, Firefox™, Chrome™, DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 110. These computing devices may include smartphones 105, laptop computers, tablets (not shown), and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features.

Thus, other aspects need not include the device itself

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC) or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

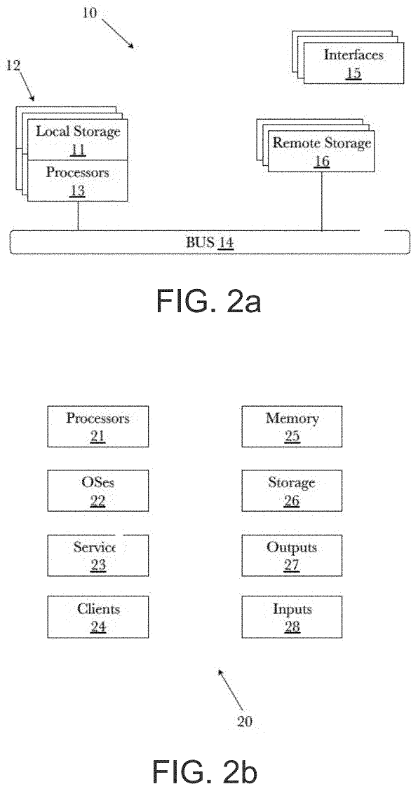

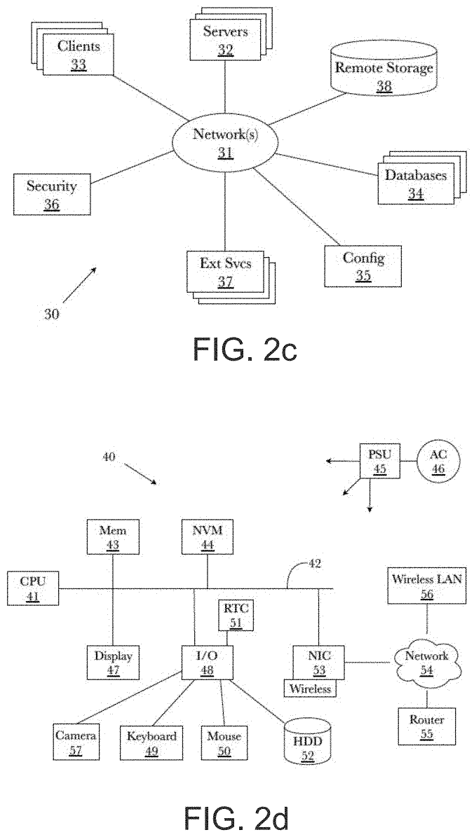

Referring now to FIG. 2a, there is a block diagram depicting an exemplary computing device 10 suitable for implementing at least a portion of the features or functionalities disclosed herein. A computing device 10 may be, for example, any one of the computing machines listed in the previous paragraph, or indeed any other electronic device capable of executing software- or hardware-based instructions according to one or more programs stored in memory. A computing device 10 may be configured to communicate with a plurality of other computing devices, such as clients or servers, over communications networks such as a wide area network, a metropolitan area network, a local area network, a wireless network, the Internet or any other network, using known protocols for such communication, whether wireless or wired.

In one aspect, a computing device 10 includes one or more central processing units (CPUs) 12, one or more interfaces 15, and one or more buses 14 (such as a peripheral component interconnect (PCI) bus). When acting under the control of appropriate software or firmware, a CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), and field-programmable gate arrays (FPGAs) for controlling operations of a computing device 10. In a particular aspect, a local memory 11 (such as non-volatile random access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art for use in mobile devices or integrated devices.

As used herein, the term “processor” is not limited merely to those integrated circuits referred to in the art as a processor, a mobile processor or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethemet interfaces, frame relay interfaces, cable interfaces, DSL interfaces, token ring interfaces, and graphics interfaces. In addition, various types of interfaces may be provided such as, for example, universal serial bus (USB), serial, ethemet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethemet interfaces, gigabit ethemet interfaces, serial ATA(SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, and fiber data distributed interfaces (FDDis). Generally, such interfaces 15 may include physical ports appropriate for communication with appropriate media. In some cases, they may also include an independent processor (such as a dedicated audio or video processor, as is common in the art for high-fidelity AN hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a JAVATM virtual machine or equivalent or files containing higher level code that may be executed by the computer using an interpreter (for example, scripts written in Python™, Perl™, Ruby™, Groovy™, or any other scripting language).

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system, and the like. In many cases, one or more shared services 23 may be operable in a system 20, and may be useful for providing common services to client applications 24. Services 23 may be, for example, WINDOWS™ services, user-space common services in a LINUX™ environment or any other type of common service architecture used with an operating system 21. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, and CD-ROM.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 2b. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, and LTE) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to bus 42, to which bus is also connected to memory 43, nonvolatile memory 44, display 47, I/O unit 48, and network interface card (NIC) 53. An I/O unit 48 typically may be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

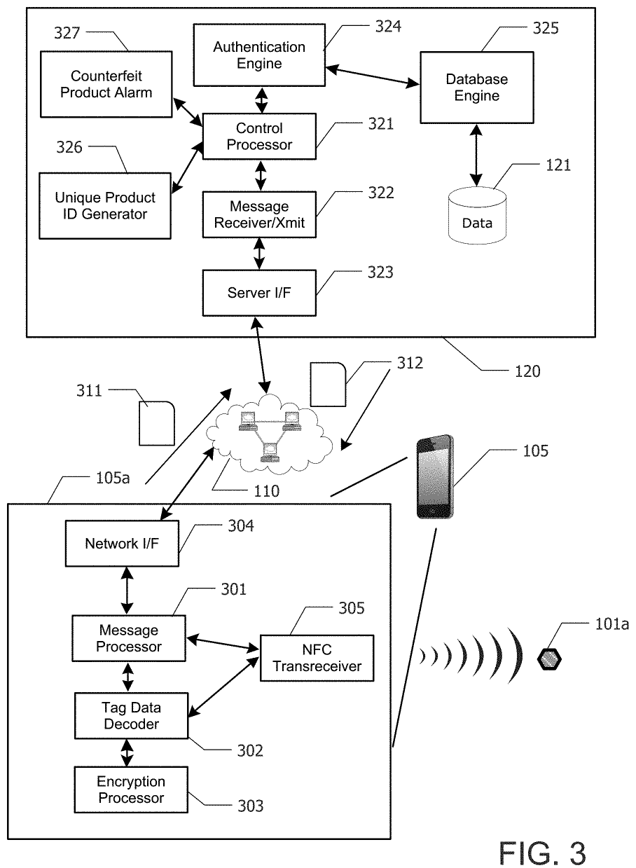

FIG. 3 illustrates another example embodiment of a system, including its software components, that identifies and authenticates a product's brand while in a distribution channel according to the present invention. The system 100 includes a server 120 and a mobile application on a smartphone 105 that communicate over the Internet 110. The server 120 has a plurality of components working together to provide its functionality. The server components include a control processor 321, a message receiver/transmitter 322, a server interface 323, an authentication engine 324 a database engine 325 coupled to a data store 121, a unique product ID generator 326, and a counterfeit product alarm 327. The mobile application105a on the smartphone 105 utilizes a plurality of processing components that include a message processor 301, a tag data decoder 302, an encryption processor 303, a network interface 304, and an NFC transceiver 305.

The message processor 301 coordinates all processing operations within the mobile application 105a. The message processor 301 instructs the NFC transceiver 305 to communicate with a tag 101a that is in a product or its packaging. The NFC transceiver 305 receives tag data in response to its transmitted signal where the tag's data are passed to the tag data decoder 302.

The tag data decoder 302, along with the encryption processor 303, decode the tag data to identify the product containing the tag 101a. The encoder processor 303 decrypts tag data before the tag data decoder 302 may use the decrypted tag data to begin an identification and authentication process. Various portions of the tag data may encode different fields of information in which the various fields are used at different parts of the authentication process to verify the product is genuine.

The decrypted tag data, in its decoded field data, are passed to the message processor 301 for use when communicating with the server 120. The message processor 301 creates a data message 311 using the decoded data fields that is sent over the Internet 110 via the network interface 304 to the server 120. The server 120 responds with a response message 312 that indicates whether the product associated with the tag data is genuine.

The response message 312 is received by the message processor 301 to update the tag data. As needed, the response message 312, or parts of it, may be passed to the tag data decoder 302 to generate updated tag data that is stored back into the tag 101a. The encryption 303 may be used as needed if the updated tag data is to be encrypted. The updated tag data are returned to the message processor 301 which stores the updated tag data onto the tag 101a. The above operations ensure that a unique identifier that changes each time it is processed, is stored within the tag 101a. If the server 320 determines that the tag data sent from the mobile application 105a does not reference a genuine product, the server may provide an error flag that the control processor 301 may pass to an operator allowing the non-genuine product to be stopped along its path through the distribution channel.

The updated tag data is used to store a variable and difficult-to-duplicate data record that is decoded as part of the authentication process. By causing the tag data to change frequently, any unauthorized individual may not be able to create a counterfeit tag to be placed in counterfeit products.

The server 120 receives a data message 311 via its server interface 323 into the message receiver/transmitter 322. The message receiver/transmitter 323 extracts the fields of tag data that are passed to the control processor 321 that coordinates all processing within the server 120. The fields of tag data are passed from the control processor 301 to the authentication engine 324 for use in authenticating the product. The authentication engine 324 communicates with product data within a datastore 121 via a database engine 325.

The control processor 301 receives an authentication determination from the authentication engine 324. The control processor 301 may use the unique product ID generator 326 to generate the response message that includes a new unique ID that will be stored into the tag 101a. The new unique ID is only needed when a genuine product has been identified within the authentication determination. When a counterfeit product has been identified, the control processor 301 provides a data packet containing all of the relevant tag data, database data, and authentication determination to the counterfeit product alarm 327 to provide notification to operators that appropriate action is to be taken. The counterfeit product alarm 327 may also generate a message to be included within the response message 312 to indicate the counterfeit product identification to the mobile application 105a.

The control processor 301 finalizes the response message 312 with any data generated by the authentication engine 324, the unique ID generator 326, and the counterfeit product alarm 327. The response message 312 is sent via the server interface 323 to the mobile application 105a over the Internet 105. The mobile application 105a uses the response message as described above.

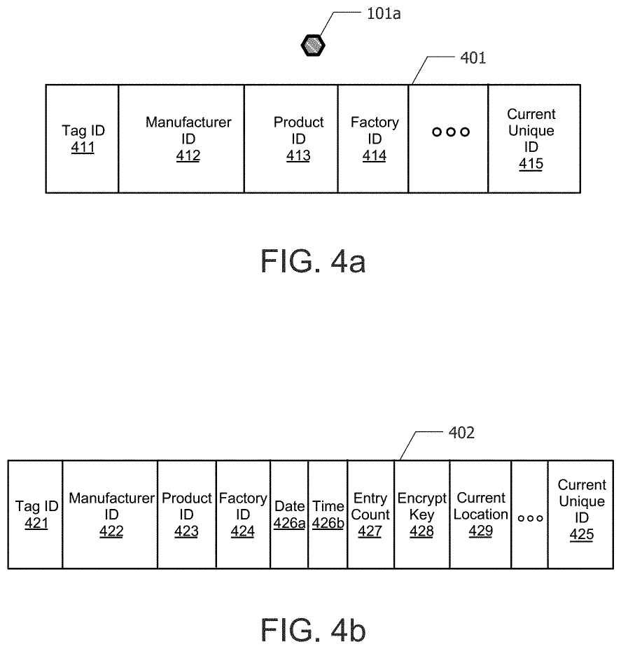

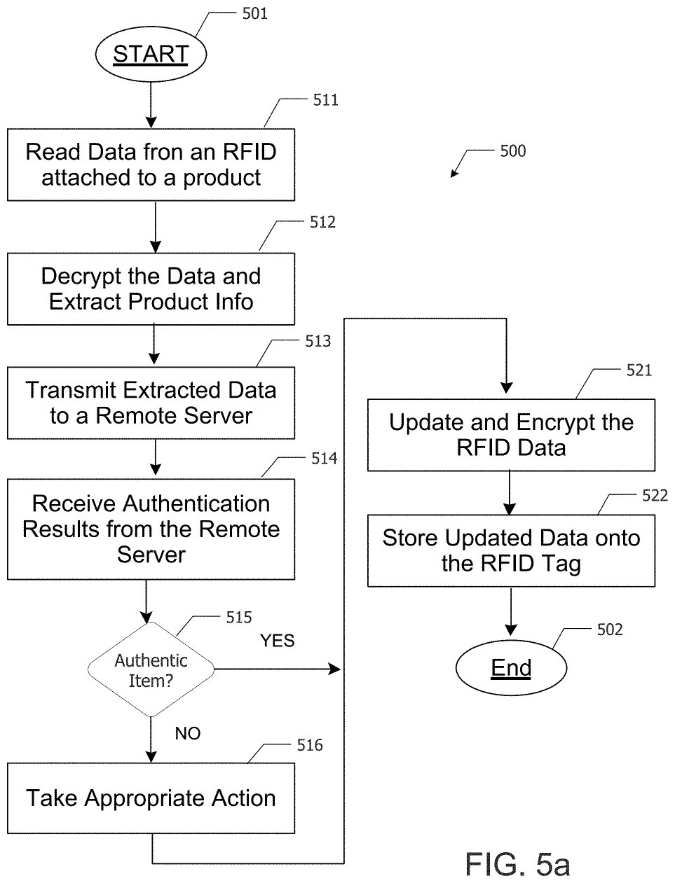

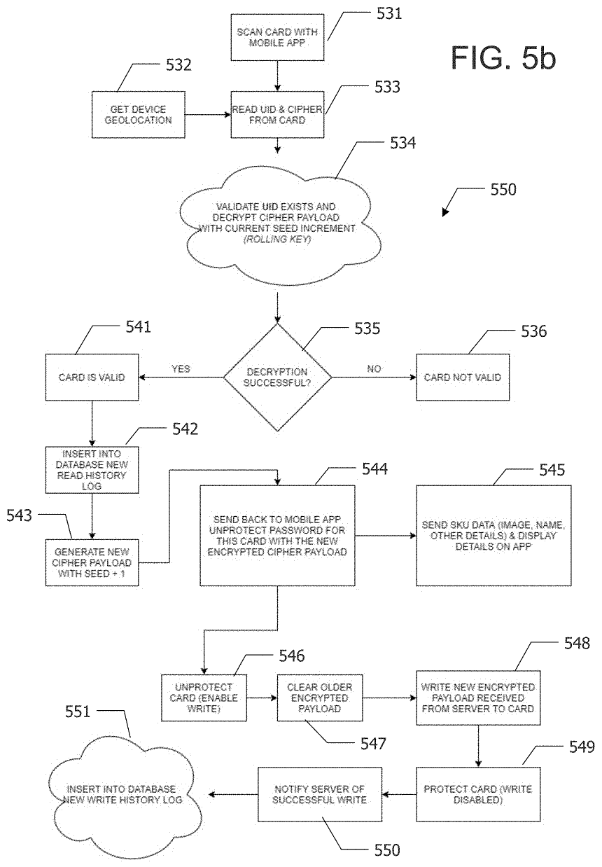

FIGS. 4a-b illustrate a data fields used within the software components of FIG. 3 to identify and authenticate a product's brand while in a distribution channel according to the present invention. FIG. 4a illustrates the data fields contained within tag data. FIG. 4b illustrates the data fields within database records processed by the database engine 325 within the server 120.

The tag data of FIG. 4a includes in part a tag ID 411, a manufacturer ID 412, a product ID 413, a factory ID 414, and a current unique ID 415. The tag ID 411 is a unique identifier for every tag to be used within the system 100. This tag ID 411 may be a serial number and is utilized when authenticating the product. Because a genuine source for the product should know, use of the serial number identifies what product was assigned to contain each particular tag 101a.

The manufacturer ID 412 is a unique identifier for the manufacturer of the product. When products are outsourced to be manufactured by third parties, the same product may be manufactured by one of many possible manufacturers. The product ID is a unique identifier that identifies a particular model of a product that may be one of many possible products from a source that may be processed by a system 100. The factory ID is a unique ID for a location where the product was created. All of these data values should be known by the entity legitimately manufacturing and selling genuine products and discrepancies between data values within tag data and expected data values stored within the datastore 121 of the server 120 may be indications of possible counterfeit products. One of ordinary skill in the art will recognize these fields may be combined together in many ways with additional data as desired to track a genuine product through a distribution channel and to authenticate the product.

The current unique ID field contains the data values described above as the unique ID that is used and updated when the tag is processed by the system. The data values in this field may be updated each time the tag data is processed as noted above. The data values may update using other ways such as when the tag data is older than a predefined length of time, when the system instructs that all tags of a certain type are to be updated, and when the product reaches certain physical locations where an increase in counterfeit activity is expected. These alternate update mechanisms may utilize and thus store additional data fields such as date, time, and location of the last tag scan.

The database data of FIG. 4b represents example data fields within the datastore 121 of the server 120. In this example, the database engine 325 may retrieve all records related to the tag and the product that have been generated as the particular product passed through the distribution channel. In a preferred embodiment, the database engine 325 will generate a new database record each time the tag data is retrieved and processed. As such, a current location and the entire transit history for a particular item will be tracked within the database.

A tag ID 421, a manufacturer ID 422, a product ID 423, a factory ID 424, and a current unique ID 425 correspond to the same fields received as part of the tag data included within the data message 311. Date 426a and time 426b fields are loaded with the time and date in which the tag data is received from the tag and/or processed within the server 120. An entry count 427 may contain a reference to the number of times a database record has been generated and stored into the data store 121. This count in the latest record should correspond to the current number of records that may be retrieved from the data store 121.

A current location 429 identifies the location of a facility in which the tag has been scanned. This field may contain location data, a facility unique identifier or other reference to the location where the tag was scanned. The encryption key 428 may contain a key used when tag data is encrypted for storage onto the tag 101a.

The above process utilizes encryption technology as follows:
RSA is one of the first public-key cryptosystems and is widely used for secure data transmission. In such a cryptosystem, the encryption key is public, and it is different from the decryption key which is kept secret. The system 100 utilizes a public and private cryptosystems to ensure trust between the NFC tag , app and server.
AES: The Advanced Encryption Standard, also known by its original name Rijndael, is a specification for the encryption of electronic data established by the U.S. National Institute of Standards and Technology in 2001. The System 100 also utilizes AES encryption to secure communication during all the process.
Rolling code: A rolling code is used in keyless entry systems to prevent replay attacks, where an eavesdropper records the transmission and replays it later to cause the receiver to “unlock.” System 100 use this layer of security to prevent cloning and replaying the transfer of security token between the RFID/NFC tag and the mobile app.
System 100 uses an encrypted revolving key as otherwise disclosed herein.

Fig. Sa illustrates a flowchart corresponding to a first embodiment for a method performed by software components that identifies and authenticates a product brand while in a distribution channel according to the present invention. The process 500 begins 501 and step 511 reads data from an RFID tag associated with an item. The RFID tag may be attached to the item and may also be embedded within product packaging containing the item. Step 512 decrypts the data read from the RFID tag and parses the decrypted data into a set of data fields associated with the item.

Data contained within the fields generated from the extracted data in Step 513 is transmitted to a remote authentication server. The remote server, in step 514, generates an authentication response and returns the response to the scanner. Test step 515 determines whether the authentication response indicates that the item is authentic, and if so, the process continues to step 521.

When test step 515 determines that the authentication response indicates that the item is not genuine, appropriate remedial action is taken step 516. Step 521 updates the data read from the RFID tag with a new Unique ID and encrypts the data before it is stored back onto the RFID tag 522. Once the updated data is on the RFID tag, the process ends 502.

Fig. Sb illustrates a flowchart corresponding to a second embodiment for a method performed by software components that use an RFID tag to identify and authenticate a product brand while in a distribution channel according to the present invention. The process begins with step 531 the scanning of a RFID tag with a mobile application and step 532 obtaining a geo-position from a smartphone. In step 533, a unique ID and cypher data is read from the RFID tag. The mobile application verifies that the unique ID exists by communicating with a remote server and then decrypts the RFID data in step 534 using the current seed increment received from the server. Test step 535 determines if the cypher data was successfully decrypted, and if not, step 536 indicates that the RFID is not valid before the process ends.

When test 535 determines that the cypher data was decrypted, the RFID tag is marked as valid in step 541. Step 542 inserts a new read data log into the database maintained on the remote server. A new cypher payload is generated using the seed incremented by 1 in step 543 which is returned to the mobile application along with a password for the RFID tag in step 544

Upon receipt of the response data from the remote server, step 454 send SKU data and other info on the item being authenticated to the mobile application for display to the user. Step 546 enables the RFID to accept data before step 547 clears the existing data from the RFID tag in step 547 and new cypher data received from the remote server is stored onto the RFID tag in step 548. Once the data has been written to the RFID tag, step 549 protects the data on the RFID tag by disabling the write to the tag. Step 550 send confirmation of the RFID data update to the remote server and the new data write history is inserted into the database on the server in step 551 as the process ends.

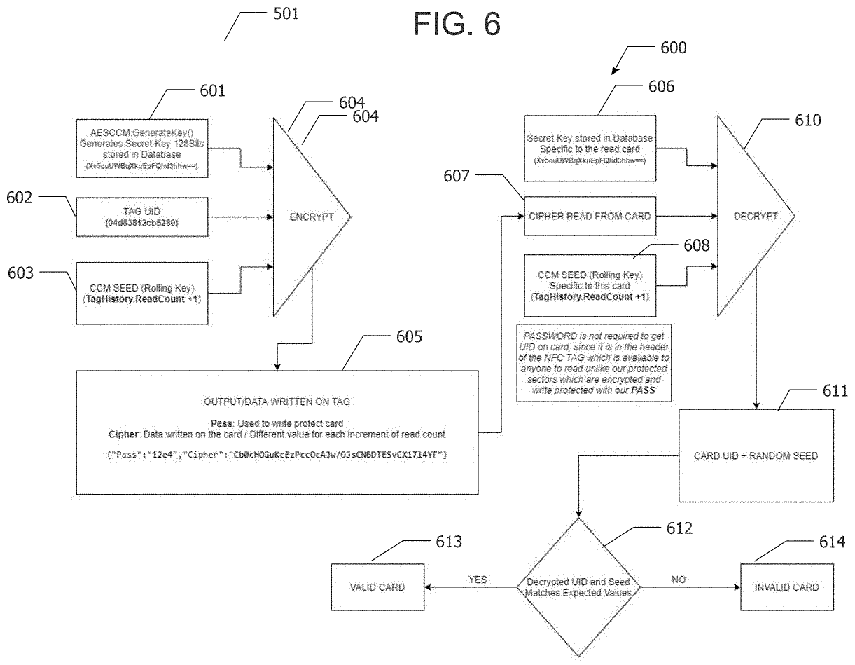

FIG. 6 illustrates a flowchart describing a method of generating a token/cypher data using encryption and decryption according to the present invention. The process 600 begins with step 601 generating a 128 bit secret key using AES. A tag ID is obtained in step 602 and a CMM seed value used in the rolling key is obtained in step 603. All of this data is combined and encrypted in step 604 using the secret key. to create cypher encrypted data that is written onto the RFID tag in Step 605.

When the RFID tag is read in step 606 to obtain the cypher data stored thereon, step 607 obtains the secret key from the database specific to this tag and generates a rolling key seed for this tag in step 608. All pf (of) these data items are used to decrypt the cypher data read from the tag in step 610.

The tag unique ID and seed value is obtained in step 611 from the decrypted data and test step 612 determines whether the decrypted unique ID and seed match the expected value from the remote server, and if is matches, step 613 indicates a positive authentication decision, otherwise step 614 indicates a negative authentication decision and the process ends.

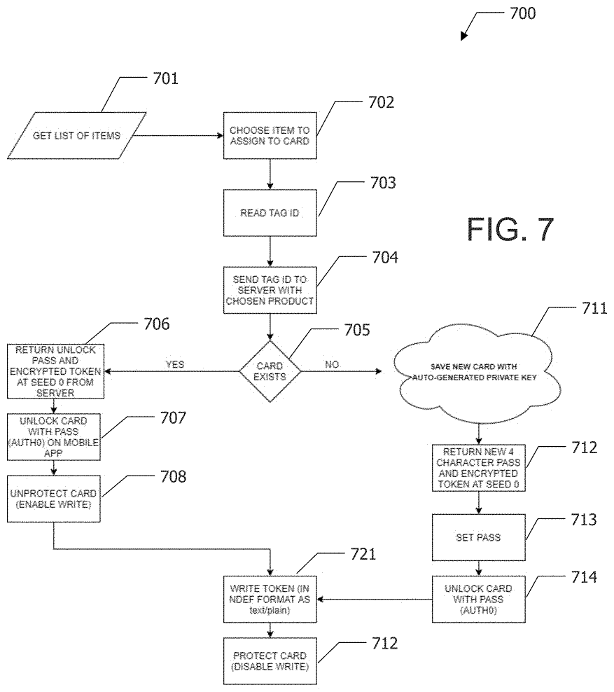

FIG. 7 illustrates a flowchart corresponding a method performed by software components that configures an RFID tag for use to identify and authenticate a product brand while in a distribution channel according to the present invention. The process 700 begins with step 701 obtaining a list of items to be authenticated using an RFID tag. Step 702 selects an item from the list to be assigned to a particular RFID tag. The RFID tag is read in step 703 which is sent to a remote server in step 704 indicating the item assigned to the tag. Test step 705 determines whether the card exists associated with the item, and if it exists, the mobile application in step 706 receives an unlock passcode and encrypted cypher data payload from the remote server. The unlock card passcode is used to unlock the RFID tag in step 707. Step 708 enables the RFID tag to be written data. The cypher data payload is written to the RFID tag in step 721 and the RFID tag is protected by disabling the write function in step 722 as the process ends.

Returning to test step 705, when the test step determines the card does not exist, step 711 saves a new RFID tag unique ID with an auto-generated private encryption key. The mobile application receives the new passcode to the RFID along with the cypher data payload in step 712. The received passcode is set onto the RFID tag in step 713 and then used to unlock the RFID tag in step 714. Once again, the cypher data payload is written to the RFID tag in step 721 and the RFID tag is protected by disabling the write function in step 722 as the process ends.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps or modules.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations. [0101] No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the invention's software or application(s) or smart device application(s) may be installed on any of the user's or operator's smart device(s), any server(s) or computer system(s) or web application(s) required to allow communication, control, transfer of content(s) or data between any combination of the components.

What is claimed is:

1. A system for identifying and authenticating an item having a product brand while in a distribution channel, the system comprising:
a mobile application for communicating with an RFID tag to store and read a unique ID and a cypher data payload; and
a remote server for maintaining an RFID tag database containing information associated with the RFID tag, the remote server generates the cypher data payload stored onto the RFID to authenticate the RFID tag as being authentic; and
the cypher data payload is generated using a rolling count key that changes each time the RFID is read;
wherein the rolling count key is generated using a unique seed value and the count of the number of times the RFID has been read.

2. The system according to claim 1, wherein the mobile application comprises:
a message processor for communicating with the remote server;
a tag data decoder for comparing the cypher data payload read from the RFID tag to authenticate the item; and
an encryption processor for encrypting and descripting the cypher data payload.

3. The system according to claim 1, wherein the remote server comprises:
a message transceiver for sending and receiving data messages from the mobile application;
a database engine for inserting and search for RFID tag data used by the mobile application;
a unique product ID generator for generating a unique ID for each RFID tag; and
an authentication engine for processing messages from the mobile application and generating authentication response messages.

4. The system according to claim 3, wherein the remote server further comprises:
a counterfeit product alarm and logger for responding to a determination that the item is not authentic.

5. The system according to claim 1, wherein the mobile application executes on a smartphone and communicates with the RFID tags using near field communication.

6. The system according to claim 1, wherein the mobile application executes on a smartphone and communicates with the RFID tags using a Bluetooth connection.

7. A system for identifying and authenticating an item having a product brand while in a distribution channel, the system comprising:
a mobile application for communicating with an RFID tag to store and read a unique ID and a cypher data payload, the mobile application comprises:
a message processor for communicating with the remote server;
a tag data decoder for comparing the cypher data payload read from the RFID tag to authenticate the item; and
an encryption processor for encrypting and decrypting the cypher data payload from the RFID tag; and
a remote server for maintaining an RFID tag database containing information associated with the RFID tag, the remote server generates the cypher data payload stored onto the RFID to authenticate the RFID tag as being authentic, the remote server comprises:
a message transceiver for sending and receiving data messages from the mobile application;
a database engine for inserting and search for RFID tag data used by the mobile application;
a unique product ID generator for generating a unique ID for each RFID tag; and
an authentication engine for processing messages from the mobile application and generating authentication response messages; and
the cypher data payload is generated using a rolling count key that changes each time the RFID is read;
wherein the rolling count key is generated using a unique seed value and the count of the number of times the RFID has been read.

8. The system according to claim 7, wherein the mobile application executes on a smartphone and communicates with the RFID tags using near field communication.

9. The system according to claim 7, wherein the mobile application executes on a smartphone and communicates with the RFID tags using a Bluetooth connection.

10. A method for providing identifying and authenticating a product brand while in a distribution channel, the method comprising:
reading cypher data payload from and RFID tag;
decrypting the cypher data payload;
extracting unique ID;
transmitting the cypher data payload and unique ID to a remote server;
receiving a new cypher data payload and encryption key from remote server;
determining whether the decrypted cypher payload data matches the expected data; and
updating the RFID tag with the new cypher data payload when the decrypted cypher payload data matches the expected data.
